(19) United States
(12) Patent Application Publication
(10) Pub. No.: US 2007/0209730 A1
(43) Pub. Date: Sep. 13, 2007

(54) Sub-sea pipe-in-pipe riser/production system

(76) Inventor: Gregory J. Miller, Friendswood, TX (US)

Correspondence Address: RICHARD A. FAGIN, P.O. BOX 1247, RICHMOND, TX, 77406-1247, US

(21) Appl. No.: 11/373,850

(22) Filed: Mar. 10, 2006

(51) Int. Cl. F16L 9/14

(52) U.S. Cl. 138/148; 138/112

(57) ABSTRACT

A low thermal conductivity pipeline includes at least one line segment. The line segment includes a first conduit having a first diameter disposed within a second conduit having a larger diameter than the first diameter and defining an annular space therebetween. The pipe segment includes at least one centralizer disposed in the annular space. The centralizer includes a plurality of spacers. The pipe segment includes a bulkhead proximate each axial end of the segment. The bulkheads seal the annular space between the first conduit and the second conduit. The annular space is substantially evacuated so as to substantially prevent conductive heat transfer through the annular space between the first conduit and the second conduit.

### CROSS-REFERENCE TO RELATED APPLICATIONS

Not Applicable

### STATEMENT REGARDING FEDERALLY SPONSORED RESEARCH OR DEVELOPMENT

Not applicable.

### BACKGROUND OF THE INVENTION

1. Field of the Invention

The invention relates generally to concentric pipe (pipe-in-pipe) hydrocarbon pipeline systems. More specifically, the invention relates to pipe-in-pipe systems which reduce heat transfer between the fluids flowing therein and the ambient environment to provide flow assurance.

2. Background Art

In subsea hydrocarbon production and transportation systems, various types of transport pipes (“pipelines”) are coupled to equipment at the uppermost end of subsea hydrocarbon producing wellbores drilled through the Earth's subsurface. The pipeline provides a path for fluids produced from the wellbores to various handling and processing devices, which may be on the water surface or may be on the sea floor at a location different from the wellbore. Where such pipelines traverse a substantial path through cold water, such as along the sea floor, and/or from great depth in the ocean to the surface, it is useful to provide some form of thermal insulation between the pipeline and the ocean water outside the pipeline. Thermal insulation reduces the possibility that the produced hydrocarbons will undergo a state change, such as the formation of gas hydrates, or substantial increase in the viscosity of produced crude oil, such that flow of the produced hydrocarbons is hampered or fails. Such state and/or viscosity changes may occur as the produced fluids, which are frequently at elevated temperatures in the subsurface Earth formations from which they are produced, are exposed to the cold temperatures of ocean water through which the pipelines extend.

It is known in the art to provide thermal insulation using so-called “pipe-in-pipe” transport conduit systems. Pipe-in-pipe systems include an inner conduit, usually made from steel or similar high strength (but highly thermally conductive) metal, surrounded by an outer conduit, also typically made from steel. The inner diameter of the outer conduit is selected to provide an annular space between the two conduits. The annular space between the inner conduit and the outer conduit is typically filled with urethane or similar thermal insulator to reduce heat transfer from the inner conduit to the outer conduit. To maintain the relative lateral position of the inner conduit inside the outer conduit, a number of centralizing devices, usually made from steel, are disposed in the annular space at spaced apart locations along the length of the pipe-in-pipe conduit. Together, the centralizers and the urethane provide substantial thermal conductivity between the inner conduit and the outer conduit, even though such conductivity is considerably less than that from a single pipe exposed to the ocean water.

The advent of deep sub-sea drilling created the new challenge of reducing the substantial heat loss in the produced hydrocarbons caused by near freezing temperature water coming in direct contact with the produced-fluid pipeline. Such heat loss led to the development of the sub-sea pipe-in-pipe conduit described above. However, there has been no significant improvement in the thermal insulation quality of pipe-in-pine conduits since they were originally developed.

The system of the present invention is intended to provide a significant reduction in heat transfer from fluids produced from the Earth's subsurface as compared with urethane-insulated, or similarly insulated pipe-in-pipe systems known in the art. The system of the present invention is also intended to be consistent with established fabrication procedures and deployment methods for pipe-in-pipe production equipment. The present invention is also intended to provide a reduction in overall weight, outer pipe size, required space, and overall system fabrication and deployment costs as contrasted with pipe-in-pipe systems known in the art.

### SUMMARY OF THE INVENTION

One aspect of the invention is a low thermal conductivity pipeline. A pipeline according to this aspect of the invention includes at least one line segment. The line segment includes a first conduit having a first diameter disposed within a second conduit having a larger diameter than the first diameter and defining an annular space between the two conduits. The pipe segment includes at least one centralizer disposed in the annular space. The centralizer includes a plurality of spacers. The spacers are made from a polymeric material. The pipe segment includes a bulkhead proximate each axial end of the segment. The bulkheads seal the annular space between the first conduit and the second conduit. The annular space is substantially evacuated so as to substantially prevent conductive heat transfer through the annular space between the first conduit and the second conduit.

Another aspect of the invention includes a method for making a low thermal conductivity pipeline. A method according to this aspect includes joining two segments of a pipeline by connecting together an inner conduit in each segment. Each segment includes a first, inner conduit having a first diameter disposed within a second, outer conduit having a larger diameter than the first diameter. Each segment includes at least one centralizer disposed between the first conduit and the second conduit. The centralizer includes a plurality of spacers made from a polymeric material. Each segment includes a bulkhead proximate each axial end of the segment. The bulkheads seal an annular space between the first conduit and the second conduit, wherein the annular space is substantially evacuated so as to substantially prevent conductive heat transfer through the annular space between the first conduit and the second conduit. The method further includes connecting together the outer conduit on each segment, and evacuating an annular space between the inner conduit and the outer conduit in a zone between each of the bulkheads proximate the axial ends of the segments being joined.

Other aspects and advantages of the invention will be apparent from the following description and the appended claims.

### BRIEF DESCRIPTION OF THE DRAWINGS

FIG. 1 shows a cut away view of one embodiment of a pipe segment according to the invention.

FIG. 2 shows an end view of one embodiment of a centralizer used between an inner pipe and an outer pipe.

FIG. 3 shows a side view of the centralizer shown in FIG. 2.

FIG. 4 shows a pipeline, made using segments according to the invention, that connects a subsea well to a production platform.

### DETAILED DESCRIPTION

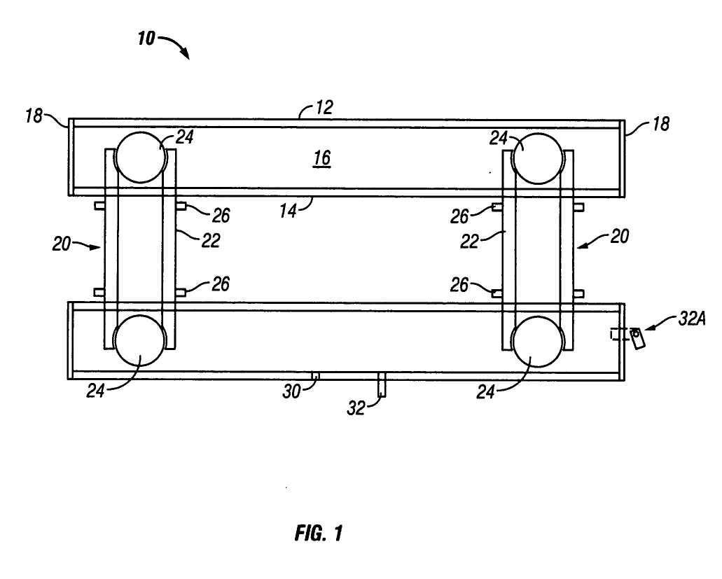

One embodiment of a segment of pipeline according to the various aspects of the invention is shown in cut away view in FIG. 1. The pipe segment 10 includes an inner pipe 14 having a selected outer diameter. The inner pipe may be made from steel, aluminum or other high strength material. An outer pipe 12, having an inner diameter greater than the selected outer diameter of the inner pipe 14 is shown surrounding the inner pipe 14. The outer pipe 12 may also be made from steel, aluminum or other high strength material. A bulkhead 18 that seals an annular space 16 between the inner pipe 14 and the outer pipe 12 is affixed such as by seal welding to each longitudinal end of both the inner pipe 14 and outer pipe 12. In the embodiment shown in FIG. 1, each bulkhead 18 may be in the form of a circularly shaped, flat plate and include a centrally disposed opening approximately the same diameter as an inner diameter of the inner pipe 14. As will be readily appreciated by those skilled in the art, flow of materials, such as crude oil, will take place in the inside of the inner pipe 14. One or more centralizers 20 may be disposed in the annular space 16 between the longitudinal ends of each of the inner pipe 14 and the outer pipe 12. The centralizers 20 are configured to retain the inner pipe 14 in a fixed position laterally within the outer pipe 12 such that there is no wall contact between the inner pipe 14 and the outer pipe 12. Preferably the centralizers 20 hold the inner pipe 14 such that it is substantially coaxial with the outer pipe 12. The one or more centralizers 20 each includes two, substantially parallel-disposed end plates 22 held in relative position by threaded fasteners 26. The end plates 22 include features arranged to retain spacers 24 therein at circumferentially spaced apart positions from each other. The spacers 24 are preferably spherically shaped, and formed from a material such as a high-durometer elastomer, or hard plastic that has low thermal conductivity, as will be further explained below. The number of, and diameters of, the spacers 24 used in the one or more centralizers 20 will depend on the lateral dimension of the annular space 16. The diameter of each spacer 24 should be substantially equal to or slightly greater than the lateral dimension of the annular space 16. An advantage of using spherically shaped spacers 24 as in the present embodiment is that the contact area between each spacer 24 and the inner pipe 14, and the corresponding contact area between the outer pipe 12 and each spacer 24 is thus minimized. By minimizing the contact area, conductive heat transfer through the spacers 24 can be minimized as well.

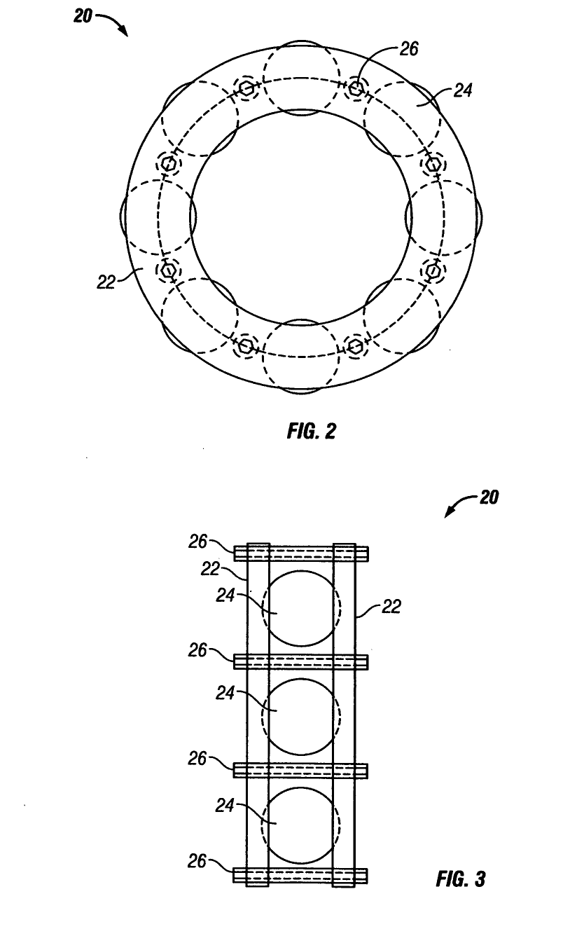

A side view of the centralizer 20 is shown in FIG. 2, and an end view thereof is shown in FIG. 3.

Referring once again to FIG. 1, those skilled in the art will readily appreciate that the segment 10 formed according to the above description will provide that the annular space 16 is substantially hermitically sealed. In one embodiment, an opening may be made in the outer pipe, and the annular space 16 can be evacuated, such as by a vacuum pump (not shown). The opening can be sealed such as by a seal weld, shown at 30. In another embodiment, a needle valve, check valve, or the like, shown schematically at 32, may be included to provide a selectable fluid passage through the wall of the outer pipe 12. The valve 32 may be opened to enable evacuation of the annular space 16, and subsequently closed to maintain vacuum therein.

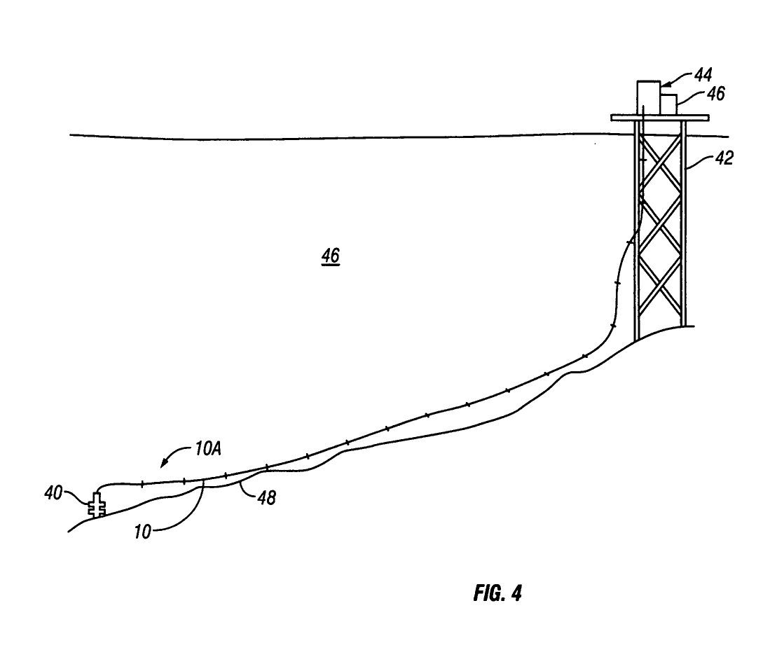

In another embodiment, a check valve 32A may be installed in the one of the bulkheads 18 that is oriented toward an end of the pipeline to which a vacuum pump (see FIG. 4) is pneumatically coupled. The purpose for such valve and pump will be further explained below with reference to FIG. 4.

Having explained the general configuration of a pipeline segment according to the invention, certain design considerations and operating principles of the invention will now be explained. The system of the present invention is based on “pipe in pipe” insulated conduit, and incorporates a high vacuum in the annular space 16 between the pipes 12, 14. The high vacuum acts in conjunction with the specially configured centralizer 20, which together perform several functions. One function of the disclosed centralizer configuration is to minimize conductive heat transfer from the inner pipe 14 or conduit to the outer pipe 12 or conduit by minimizing the contact area with the pipes 12, 14. Another function of the centralizer 20 is, as previously explained, centralizing of the inner pipe 14 within the outer pipe 12. Still other attributes of the centralizer 20 result in easier fabrication of the pipe-in-pipe system, and provision for limited axial movement of the inner pipe 14 within the outer pipe 12.

The design of the pipe-in-pipe system of the invention addresses the two primary sources of conductive heat loss in prior art systems, which are roughly equal in magnitude and include the thermal conductance of prior art steel centralizers, and the conductive heat losses through the urethane, or other prior art insulation material used to fill the annular space. The vacuum and centralizer will be described in more detail below.

1. Vacuum in the Annular Space: Having vacuum in the annular space is based on the established principles of the Dewar Flask, whereby very high vacuum between two spaced apart surfaces substantially eliminates the thermally conductive medium between the two spaced apart surfaces, thus substantially preventing conductive heat transfer through the space separating the surfaces. By essentially eliminating gas and most solid material disposed between the inner pipe 14 and the outer pipe 12, substantially all heat loss by conduction is eliminated. A particular advantage of such reduction in conductive heat loss enables to reducing the lateral dimension of the annular space 16 between the inner pipe 14 and the outer pipe 12. As will be readily appreciated by those skilled in the art, prior art insulation filled pipe-in-pipe systems could be designed to reduce conductive heat loss by increasing the size of the annular space, such that the insulation layer thickness would be correspondingly increased. However, increasing the annular space dimension requires either or both increasing the diameter of the outer pipe, thus increasing size and weight of the pipe-in-pipe system, or decreasing the diameter of the inner pipe, this reducing the flow capacity of the pipe-in-pipe system. Reducing the necessary size of the annular space 16 enables, in particular, reducing the size of the outer pipe 12 to maintain only a very small annular space, as small as on the order of ¼ inch, such that the size and weight of the pipe-in-pipe system for any inner pipe diameter is minimized.

The vacuum in the annular space can be obtained in the pipe-in-pipe system of the invention during fabrication, in a number of different embodiments, for example along an entire pipe segment (“joint”) or along a predetermined length of pipe line, in one embodiment about 160 feet.

In some embodiments, a segment of pipe-in-pipe can be sealed at its axial ends, or close to its axial ends, by seal welding the bulkhead 18 or similar gas tight barrier to close the annular space 16 between the inner pipe 14 and the outer pipe 12, as explained above. A needle valve and/or check valve 32 may be included through one or both such bulkheads. After seal welding, the valve 32 may be connected to a vacuum pump to evacuate the annular space to a selected vacuum level. Thus, individual segments, or combinations of segments, may be shipped to a location for use with vacuum already in place.

The foregoing process of making such vacuum-annulus pipe segments offers a number of advantages as compared with building a pipeline in its entirety and evacuating the annulus after building. First, it is impracticable to evacuate the annulus of a long (several km to tens or hundreds of km) pipeline from a single or limited number of evacuation points, if only because of the total volume of annular space. Second, the large number of separated vacuum compartments in a pipeline made in sealed segments will reduce the chance of failure of insulation over the entire pipeline in the event of breach of one or more of the outer pipe segments. In addition, those skilled in the art will appreciate that if the pipeline traverses a large change in elevation, such as may frequently be the case in deep marine environments, it is essentially impossible to evacuate the lowest elevation portion of the annular space from a higher elevation due to Earth's gravity when the pipeline is in its installed configuration. By evacuating the individual pipeline segments during the manufacturing process, the need to evacuate an annulus over great elevation change is eliminated.

When the individual segments of the pipe are welded together to form a pipeline, there will be, as a practical matter, atmospheric pressure in the section of pipe between two successive bulkheads as a new segment is joined to the already assembled portion of the pipeline. In a method of making a pipeline according to the invention, after a new segment is welded to the already completed portion of the pipeline, an opening may be formed in the outer pipe within an axially located zone defined between the bulkheads in the two just-joined together segments of pipe. After making the opening, the annular space between the bulkheads is evacuated and the opening is seal welded. Thus, the annular space between the newly joined segment and the completed section of the pipeline is also evacuated. This process is repeated until the entire pipeline is finished.

With very high vacuum in the annular space the only heat loss through the annular space would be attributed to “radiant heat transfer”, which would only be very small fraction of the heat loss otherwise attributable to conduction.

2. The Centralizer: The centralizer (20 in FIG. 1) is intended to serve several purposes, from the fabrication point to permanent deployment. The centralizer is specifically sized for each particular inner and outer pipe size, and typically consists of an arrangement of a selected number of spherical spacers, as explained above with reference to FIG. 1, typically twelve or more depending on the lateral dimension of the annular space between the inner pipe and the outer pipe. The spacers, also as explained above, are held in relative positions by means of a structural carriage (end plates 22 in FIG. 1), similar in principle to a ball cage in a ball bearing. In one embodiment, the spheres consist of a high durometer polymeric material, such as high density polyethylene (HDPE). In some embodiments, the spacers are about the same or slightly larger in diameter than the thickness of the annular space, and are in the latter case thus sized to cause an interference fit between the spacers and the walls of the inner and outer pipes. The spacer design serves several key functions, which include facilitation of assembly of the inner pipe within the outer pipe, centering the inner pipe within the outer pipe, enabling limited relative axial movement between the inner and outer pipes, and providing a minimum of direct contact surface area between the inner and outer pipe. The centralizer also serves as a conveyor, which facilitates the installation of the outer pipe over the inner pipe, during the fabrication process, and maintains the inner and outer pipe in a centered position for subsequent welding.

A pipe in pipe system made according to the various aspects of the invention may offer one or more of the following benefits:

a) substantial reduction in heat loss, through thermal conductivity, and greatly enhanced flow assurance;

b) reduced outer pipe diameter, by at least one standard pipe diameter as contrasted with correspondingly sized insulated pipe-in-pipe systems known in the art;

c) reduced weight of the total system for the same inner diameter (and corresponding flow capacity;

d) reduced cost of material, fabrication, and deployment;

e) elimination of moisture from the annulus, and thus reduced chance of corrosion damage to the inner pipe;

f) rapid warning of any annulus breach; and

g) substantial increase in flow assurance, by reducing “cold spots” with concomitant formation of solids from fluid flow, among other benefits.

The pipe-in-pipe system of the present invention is a significant departure from traditional pipe-in-pipe riser/pipeline fabrication and designs. The system of the invention takes into account all of the key elements of fluid flow assurance, structural integrity, reliability, safety, practical application, and cost. The initial objective in developing the present invention was to examine every aspect of heat transfer in a pipeline and to consider all viable and proven options that could conceivably reduce the high heat losses of traditional systems. It is concluded that, in a typical pipe-in-pipe system known in the art prior to the present invention, approximately half of heat loss is through the insulation barrier and the other half of heat loss is through the welded centralizer system. It is recognized that the secondary function of the centralizer is to reduce the likelihood of pipe buckling under bending stress, which should be considered in each specific application.

It is expected that the heat loss associated with the system of the invention will be substantially reduced as contrasted to prior art insulated pipe in pipe systems, and would typically show reductions thereof exceeding 90%, depending upon the specific application, and ultimate structural design. The significant increase in thermal efficiency offered by the invention is sufficient to warrant the close examination of production requirements at the platform level, as well as enhanced transport options. For those reasons, the reduced costs of this system have direct implication on other aspects of the overall production system, which could conceivably have even greater cost applications.

The system of the invention presents the opportunity for a substantial increase in the efficiency of deep sub-sea pipe-in-pipe systems, which is well within the realm of established fabrication and deployment methods. The high level of thermal efficiency justifies serious consideration in the overall project planning process, because of all of the related project elements, such as supplemental heating, required pumping power, practical sub-sea transport distances, etc. The performance is predictable and quantifiable, using existing accepted engineering and thermal models, for planning purposes. It is believed that the system of this invention has immediate benefits with regard to deep sub-sea riser applications, as well as sub-sea production lines from platforms to terminals, where terminal temperature is a critical consideration.

One contemplated use for a pipeline, made from segments as explained with reference to FIG. 1, is shown schematically in FIG. 4. A wellbore drilled through Earth formations below the bottom 48 of a body of water 46 such as the ocean terminates at its upper end at a source of fluid flow, such as a wellhead 40 of types known in the art for subsea well completion and flow control. A pipeline 10A connects the wellhead 40 to a fluid flow destination such as production processing equipment 44, 46 disposed on a production platform 42. The platform 42 in the present embodiment may be bottom supported, but the type of platform is not intended to limit the scope of the invention. The pipeline 10A is made from a plurality of pipe segments 10 made substantially as explained above with reference to FIG. 1. As explained in the Background section herein, the pipeline 10A may extend for a great distance along the water bottom 48 where temperature of the water can be approximately 0 degrees C. In prior art pipelines, heat loss between the location of the wellhead 40 and the platform 42 may result in solids flocculating out of, or congealing out of, the fluid flowing in the pipeline. A pipeline 10A according to the invention will suffer substantially lower heat loss under similar environmental conditions as contrasted with prior art pipelines.

In the embodiment shown in FIG. 4, each segment 10 may include a one way or “check” valve in the bulkhead disposed on the platform side of the segment (see 32A in FIG. 1), wherein the flow direction of such check valve is toward the platform 42. The production equipment on the platform 42 may include a vacuum pump 44 pneumatically coupled to the annular space (16 in FIG. 1). The vacuum pump 44 may operate during operation of the pipeline 10A such that small fluid leaks into the annular space may be overcome by the action of the vacuum pump 44 such that vacuum therein is substantially maintained. By providing check valves (32A in FIG. 1) as explained, the pipeline 10A may be assembled from segments 10 having the annular spaces thereof pre-evacuated.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A low thermal conductivity pipeline, comprising:
at least one line segment, the line segment including a first conduit having a first diameter disposed within a second conduit having a larger diameter than the first diameter and defining an annular space therebetween;
at least one centralizer disposed in the annular space, the centralizer including a plurality of spacers; and
a bulkhead proximate each axial end of the segment, the bulkheads sealing the annular space, the annular space substantially evacuated so as to substantially prevent conductive heat transfer through the annular space between the first conduit and the second conduit.

2. The pipeline of claim 1 further comprising a plurality of the line segments coupled end to end between a source of fluid flow and a fluid flow destination.

3. The pipeline of claim 2 wherein each segment includes a check valve disposed in one of the bulkheads disposed toward the destination, and wherein the pipeline further comprises a vacuum pump in pneumatic communication with a destination of the annular space.

4. The pipeline of claim 1 wherein the spacers are spherically shaped and spaced apart circumferentially within the annular space, and wherein the spacers are retained by end plates coupled on opposed sides of the spacers.

5. The pipeline of claim 1 wherein the spacers have diameter selected to provide an interference fit between the first conduit and the second conduit.

6. The pipeline of claim 1 wherein the spacers are formed from a low thermal conductivity material.

7. The pipeline of claim 6 wherein the spacers comprise high density polyethylene.

8. A method for making a low thermal conductivity pipeline, comprising:
joining two segments of a pipeline by connecting together an inner conduit in each segment, each segment including a first, inner conduit having a first diameter disposed within a second, outer conduit having a larger diameter than the first diameter, each segment including at least one centralizer disposed between the first conduit and the second conduit, the centralizer including a plurality of spacers, each segment including a bulkhead proximate each axial end of the segment, the bulkheads sealing an annular space between the first conduit and the second conduit;
connecting together the outer conduit on each segment; and
evacuating an annular space between the inner conduit and the outer conduit in a zone between each of the bulkheads proximate the axial ends of the segments being joined.

9. The method of claim 8 further comprising joining a plurality of the line segments end to end between a source of fluid flow and a fluid flow destination.

10. The method of claim 9 wherein each segment includes a check valve disposed in one of the bulkheads disposed toward the destination, the method further comprising vacuum pumping the annular space from the destination end of the pipeline during fluid flow therethrough.

11. The method of claim 8 wherein the spacers are spherically shaped and spaced apart circumferentially within the annular space, and wherein the spacers are retained by end plates coupled on opposed sides of the spacers.

12. The method of claim 8 wherein the spacers have diameter selected to provide an interference fit between the first conduit and the second conduit.

13. The method of claim 8 wherein the spacers are formed from a low thermal conductivity material.

14. The method of claim 13 wherein the spacers comprise high density polyethylene.

15. A low thermal conductivity pipeline, comprising:
a plurality of line segments coupled end to end between a source of fluid flow and a fluid flow destination, each line segment including a first conduit having a first diameter disposed within a second conduit having a larger diameter than the first diameter and defining an annular space therebetween;
at least one centralizer disposed in the annular space, the centralizer including a plurality of spacers; and
a bulkhead proximate each axial end of the segment, the bulkheads sealing the annular space, the annular space substantially evacuated so as to substantially prevent conductive heat transfer through the annular space between the first conduit and the second conduit.

16. The pipeline of claim 15 wherein the source of fluid flow comprises a wellhead and the destination comprises a production platform.

17. The pipeline of claim 15 wherein each segment includes a check valve disposed in one of the bulkheads disposed toward the destination, and wherein the pipeline further comprises a vacuum pump in pneumatic communication with a destination of the annular space.

18. The pipeline of claim 15 wherein the spacers are spherically shaped and spaced apart circumferentially within the annular space, and wherein the spacers are retained by end plates coupled on opposed sides of the spacers.

19. The pipeline of claim 15 wherein the spacers have diameter selected to provide an interference fit between the first conduit and the second conduit.

20. The pipeline of claim 15 wherein the spacers are formed from a low thermal conductivity material.

21. The pipeline of claim 20 wherein the spacers comprise high density polyethylene.
